(19) United States
(12) Patent Application Publication
(10) Pub. No.: US 2017/0323386 A1
(43) Pub. Date: Nov. 9, 2017

(54) SYSTEMS AND METHODS FOR DETERMINING AND DYNAMICALLY ADJUSTING RISK CAPACITY

(71) Applicant: Ellevest, New York, NY (US)

(72) Inventors: Sylvia Kwan, San Francisco, CA (US); Michael Smith, New York, NY (US); Melissa Cullens, New York, NY (US); Alexandria Stried, New York, NY (US)

(73) Assignee: Ellevest, New York, NY (US)

(21) Appl. No.: 15/586,702

(22) Filed: May 4, 2017

Related U.S. Application Data
(60) Provisional application No. 62/332,870, filed on May 6, 2016.

(51) Int. Cl. G06Q 40/06

(52) U.S. Cl. CPC G06Q 40/06

(57) ABSTRACT

A system for determining risk capacity for portfolio recommendations is provided that includes a user interface that inputs user information and goals. A rules base engine receives the user information and derives risk capacity, wherein the rules base engine provides the user initial portfolio recommendations that are based on the derived risk capacity and goals as well as automatically rebalancing the derived risk capacity as a time horizon approaches.

### PRIORITY INFORMATION

This application claims priority from provisional application Ser. No. 62/332,870 filed May 6, 2016, which is incorporated herein by reference in its entirety.

### BACKGROUND OF THE INVENTION

The invention is related to the field of portfolio management, and in particular for determining and dynamically adjusting risk capacity.

The rise of the Internet provided a continual introduction of applications and services to enable individuals and organizations to conduct financial research, manage their financial portfolios, and engage in certain types of financial transactions. Example of these applications and services include on-line banking to stock quote and financial information services to sites that enable users to engage in on-line, real-time market trades involving various instruments such as stocks, stock options, bonds, and mutual funds. Moreover, trading companies include in their services to clients online platforms permitting trading of standard instruments in recognized markets.

In such services, the investor uses credit or an account set up through the trade service to engage in trades through the service's proprietary system and interfaces. Such services, which are geared towards individual investors, do not permit seamless integration with users' internal or back-end systems or the creation and trading of customized transactions. These services, and many others like them, do not enable trading that are based on the prioritizing personalized goals of the investors. The invention addresses this problem.

### SUMMARY OF THE INVENTION

According to one aspect of the invention, there is provided a system for determining risk capacity for portfolio recommendations. The system includes a user interface that inputs user information and goals. A rules base engine receives the user information and derives risk capacity, wherein the rules base engine provides the user initial portfolio recommendations that are based on the derived risk capacity and goals as well as automatically rebalancing the derived risk capacity as a time horizon approaches.

According to another aspect of the invention, there is provided a method for determining risk capacity for portfolio recommendations. The method includes inputting user information and goals using a user interface structure, and deriving risk capacity based on the user information and goals using a rules based engine. Moreover, the method includes providing the user initial portfolio recommendations that are based on the derived risk capacity and goals, and automatically rebalancing the derived risk capacity as a time horizon approaches.

### BRIEF DESCRIPTION OF THE DRAWINGS

FIG. 1 is a schematic diagram illustrating a general overview of the inventive system for adjusting risk capacity;

FIG. 2 is a schematic diagram illustrating the architecture of the inventive system; and

FIG. 3 is a schematic diagram illustrating the process flow of the invention.

### DETAILED DESCRIPTION OF THE INVENTION

The invention describes a web-based system for establishing and prioritizing personalized financial goals holistically, where changes to one goal affect the other goals. Financial planning and investment management can be integrated in a single holistic service, and portfolio risk is automatically reduced over time as goal target dates approach (i.e. target date fund 2.0). Moreover, the invention can establish investor risk tolerance by identifying financial goals (rather than asking for risk tolerance in a questionnaire), monitors investor progress toward financial goals, and providing personalized tips when they fall off track. Multiple data sources (such as social comparisons, local home values, individual account balances, income, and portfolio projections) can be aggregated and abstracted to establish individualized investment plans.

Also, the invention provides a holistic focused approach for goals based financial and investment advice, and can offer a goals-based financial planning and investment management service specifically designed for specific groups of investors, such as women, that goes beyond other digital offerings as well as being tailored to service the needs of specific type of investors. The following features are unique to the invention:
a. Recommendations that incorporate the expected longer longevity for women.
b. Portfolios designed with less investment risk, reflecting industry and academic research showing that women are generally more risk aware, all else being equal, and prefer more certainty to taking chances.
c. Simulation of outcomes based upon investment recommendations that decrease in risk over time, to more accurately project performance of portfolios that rebalance more conservatively as target dates approach.
d. Display of outcomes with a higher than 50% likelihood, to incorporate a higher level of certainty than is typical among other financial advisors.
e. Features that allow exploration of the financial impact of common decisions users make, such as career breaks to care for children or elderly parents.
f. Use of specific salary curves in the simulation of outcomes.
g. Assess and assigns the risk to the user where all other digital investment advisors ask the user what their risk tolerance is overall/for each account.
h. Use of goals common to selective groups such as savings for children and starting a business.

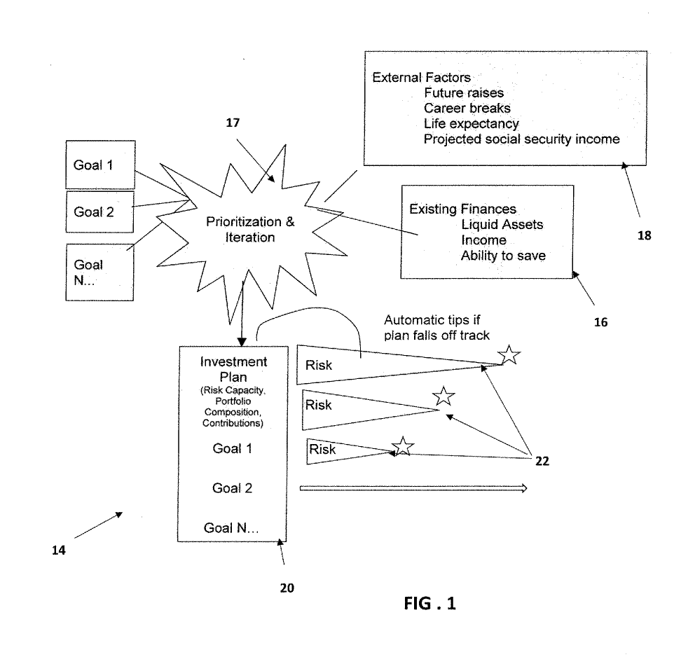

FIG. 1 shows an a general overview of the inventive system 14. A user provides system 14 a plurality of goals (Goal 1, Goal 2 . . . Goal N) that are processed together with information regarding existing finances 16 (e.g., liquid assets, income and ability to save), as well as information regarding external factors 18 (such as future raises, career breaks, life expectancy, projected social security income or the like) to provide a realistic prioritization and iteration of financial goals 17 to yield an investment plan 20 (including risk capacity, portfolio compensation, and contributions) for Goals 1, 2, . . . N. The process is iterative over time, and over time, the system 14 may provide feedback (such as using automated tips if the plan falls off track), and the portfolio risk 22 automatically decreases over time.

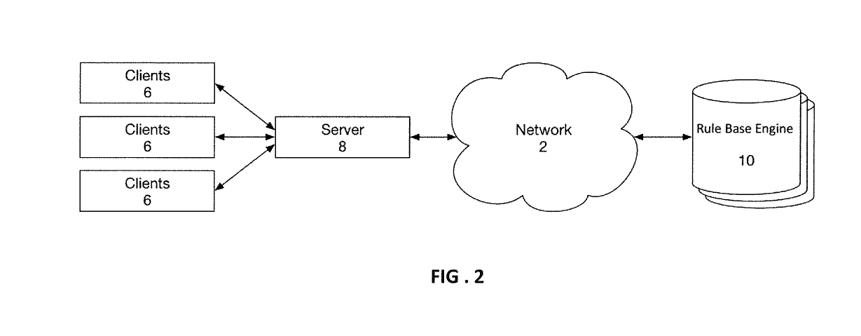

FIG. 2 shows the architecture of the inventive system 14. The invention operates in a network 2 that may communicate through a cloud. The network 2 works in conjunction with multiple client systems 6 that can communicate with each other as well with associated server systems 8. Each of the client systems 6 are computer systems, having one or more CPU, RAM, ROM, and external memory sources for operation. Many times, the user will interact with a client system 6 to perform the operations of the invention. Also, the client systems 6 are equipped with communication protocols needed to communicate in the network 2, such as TCP/IP as well as other encoded communication mechanisms.

When a user interacts with a client system 6, the client system 6 needs to communicate with a server system 8. The server system 8 receives operations, such as commands or requests, by the client systems 6 to be performed and the results of these operations being sent to their respective client systems 6. The server system 8 might need to access information that is stored externally in a rules base engine 10. The rules base engine 10 can include one more data repositories. The data repositories can be database systems or hardware memory elements, such as a network drive. The server system 8 and rules base engine 10 can include communication protocols needed to communicate in the network 2, such as TCP/IP as well as other encoded communication mechanisms. Note in other embodiments of the invention there can be more than one server operating within the network 2.

The invention provides recommendations for a user's target goal amounts, initial funding, ongoing savings, and investment portfolios for achieving a user's desired financial goals, after gathering a minimal set of personal and financial information. Moreover, the invention also provides users with a forecast of the financial outcomes associated with the investment plan and recommendations.

The digital experience begins with a set of user provided inputs, including age, income, zip code of residence, and financial account information. The user is presented with a menu of common financial goals, such as a home purchase, retirement, and starting a business via a user interface. The user interface can include a web browser or any kind of mechanism that allows a user to enter information that later be used by the system 14 for processing. Once the user has chosen and prioritized their goals, the system 14 determines estimated target amounts for each goal, personalized to their personal and financial information.

For example, if the user has a home goal, the system 14 utilizes a third party calculator to determine the home cost the user can afford, based upon her current salary and where the user currently resides. The system 14 provides proprietary target amount determination for each goal leveraging its rules base engine 10.

The estimated target amounts are presented to the user, who can then accept or adjust the amounts to their preferences. Once the user has confirmed the target amounts for each goal, the system 14 runs a set of algorithms associated with the rules engine 10 to provide the user with a holistic set of recommendations on how to achieve their chosen goals. The invention leverages the rules base engine 10 that provides the necessary rules and guidelines for assessing the appropriate holistic set of recommendations. The rules based engine 10 aggregates and abstracts from multiple data sources information needed to devise individualized investment plans. The system 14, leveraging the rules base engine 10, provides recommendations based upon the priority of goals the user established, together with the financial resources the user entered earlier, and delivers feedback on which goals are currently achievable and which goals should be saved for future consideration.

For each goal, the user receives funding, ongoing savings, investment horizon, and portfolio recommendations, within the constraints of their financial resources and the recommended savings amounts provided by the system 14. The system 14 also determines, using a 3rd party Monte Carlo simulation, a probable and reasonable range of financial outcomes associated with each goal. Hence, the user can easily see forecasted results associated with the system's recommendations.

After reviewing the system's recommendations and associated outcomes, the user has full control to personalize their investment plan and immediately see the impact of their decisions on the achievement of their financial goals. The use can also add, delete, or change the priority of goals. This aspect of the invention is unique; it empowers the user to make changes and tradeoffs in a holistic fashion. The user can choose whether to keep within the constraints of their financial resources and capacity to save or to explore possibilities beyond those limitations.

The system 14 provides recommendations based upon risk capacity and not risk tolerance. Also, the system 14 provides initial portfolio recommendations that are based upon perceived risk capacity, which differs from goal to goal and for some goals, person to person. Other advisors, both digital and traditional, use risk tolerance, money personality questionnaires, or other tools that place the burden of assessing risk tolerance on the user, who often has little, if any, idea how to determine that for themselves. The invention challenges the use of risk tolerance, instead helping the user focus on the amount of risk they should take in order to reach their financial goals. Users see outcomes associated with the portfolio recommendations and have the opportunity to adjust the portfolio recommendations directly or indirectly by changing the investment horizon associated with the goal. Recommendations and advice is also provided for a user's held away tax advantaged accounts.

Moreover, the system 14 provides the capability to customize all aspects of a user plan and see future impact. Although the system 14 requires a very small set of data from the user, it provides a personalized set of recommendations, from which the user can further customize in accordance to their financial resources, savings capacity, and risk preference. Users can interactively explore how changing the target, savings, initial funding amounts, and horizon recommendation for one goal impacts the projected outcome for not only that goal, but the achievement and projected outcomes of the other goals in their plan as well. Providing the user with the ability to explore a wide range of ‘what-if’ decisions and see the impact of those decisions on their outcomes empowers them to make more effective decisions towards the achievement of their goals. In addition, the system 14 allows a user to explore decisions that impact all of their goals, such as “What happens to my investment plan if I take a career break, or get a raise in salary?”

For example, a user can also explore how decisions common to women, such as taking a career break, may impact the achievement of their goals. This holistic view, along with the ability to explore future outcomes of multiple goals based upon decisions and tradeoffs made today, goes well beyond other digital advice offerings currently available.

The system 14 provides a holistic picture of a user plan, not just goals in isolation. The system allows users to explore and immediately see the impact of tradeoffs among all of their goals, not just one goal at a time.

The system 14 provides recommendations and advice for held away accounts, and provides both specific investment advice and management for accounts held at the firm, as well as asset allocation advice for held away accounts. Moreover, the system 14 provides reporting based upon progress towards goals, not investment performance against an arbitrary benchmark, and actively monitors the user's progress towards the goals that the user has implemented. If the user starts to fall short of achieving her goal, the system 14 can automatically alert the user. Once the user returns to the system 14, the user receives specific advice and recommendations on how they can get back on track.

The system 14 provides implementation and Ongoing Advice. Users may implement a goal at any time by opening an investment account and providing the initial funding for the goal. Also, the system 14 establishes user specified automated ongoing savings towards that goal. Portfolios for multiple goals may be held in a single custodial account.

In addition, the system 14 has the built-in flexibility to update financial advice and recommendations as users' circumstances change. This is accomplished by allowing users to add, edit, or delete goals, add and/or change financial and personal information, and see the impact of those changes on their investment plan. If the outcomes are unsatisfactory, the system 14 provides recommendations to help the user get back on track. The user then has the full capability to personalize their recommendations and make the tradeoffs that are appropriate for them.

The user experience described above is completely digital, implemented using proprietary technology. The underlying technology that drives the user experience, algorithms and recommendations allows the system 14 to scale to millions. The open and flexible technological framework allows the system to expand to integrate new functionality and enhanced features, such as recommendations and investment plans over time, not just for today. The architecture is built around modular components for organizing and calculating different aspects of the investment plans. The inventive system's open architecture allows for utilizing existing technologies from domain experts while building other modules internally. This allows the invention to integrate and utilize multiple components (including third party systems) for algorithmic steps such as (but not limited to):
Defining a goal target for purchasing a house using an affordability calculator for housing prices in the user's zip code
Forecasting achievable results using the Wealth Forecasting Engine (WFE), a Monte Carlo simulation method provided by Morningstar Investment Management, LLC.
Representing achievable and projected results across multiple modalities including XML, JSON/REST and HTML.

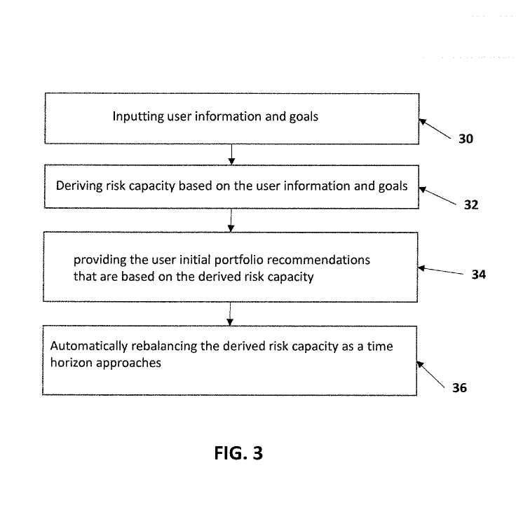

FIG. 3 shows a process flow of the invention. The invention provides a method for determining risk capacity for portfolio recommendations including the steps of inputting user information and goals (shown in step 30), deriving risk capacity based on the user information and goals (shown in step 32) using the rules base engine 10, providing the user initial portfolio recommendations that are based on the derived risk capacity and goals using the rules base engine 10 (shown in step 34), and automatically rebalancing the derived risk capacity as a time horizon approaches (shown in step 36). These steps include the techniques herein to help implement these steps.

In addition, given the nature of the projections required, the invention is built to provide both on-demand results as well as manage requests in an asynchronous fashion for results that may take a longer period of time to generate.

Although the present invention has been shown and described with respect to several preferred embodiments thereof, various changes, omissions and additions to the form and detail thereof, may be made therein, without departing from the spirit and scope of the invention.

What is claimed is:

1. A system for determining risk capacity for portfolio recommendations comprising:
a user interface for inputting user information and goals; and
a rules base engine that receives the user information and derives risk capacity, wherein the rules base engine provides the user initial portfolio recommendations that are based on the derived risk capacity and goals as well as automatically rebalancing the derived risk capacity as a time horizon approaches.

2. The system of claim 1, wherein the user information includes asset information and income information.

3. The system of claim 1, wherein the risk capacity is derived based on the user information and goals over time until the time horizon.

4. The system of claim 3, wherein the automatic rebalancing occurs at least one interval during the time until the time horizon.

5. The system of claim 1, wherein the user's progress towards the goals is actively monitored.

6. The system of claim 1, wherein the user adjusts the portfolio recommendations directly or indirectly by changing the investment horizon associated with the goal.

7. The system of claim 1, wherein the rules base engine aggregates and abstracts from multiple data sources to establish individualized investment plans.

8. The system of claim 1, wherein the rules based engine comprises a set of algorithms to provide the user with a holistic set of recommendations on how to achieve their goals.

9. The system of claim 1 further comprising modular components for organizing and calculating different aspects of investment plans.

10. The system of claim 1 further comprising means for integrating new functionality for deriving risk capacity.

11. A method for determining risk capacity for portfolio recommendations comprising:
inputting user information and goals using a user interface structure;
deriving risk capacity based on the user information and goals using a rules based engine;
providing the user initial portfolio recommendations that are based on the derived risk capacity and goals; and
automatically rebalancing the derived risk capacity as a time horizon approaches.

12. The method of claim 11, wherein user information includes asset information and income information.

13. The method of claim 11, wherein the risk capacity is derived based on the user information and goals over time until the time horizon.

14. The method of claim 13, wherein the automatic rebalancing occurs at least one interval during the time until the time horizon.

15. The method of claim 11, wherein the user's progress towards the goals is actively monitored.

16. The method of claim 11, wherein the user adjusts the portfolio recommendations directly or indirectly by changing the investment horizon associated with the goal.

17. The method of claim 11, wherein the rules base engine aggregates and abstracts from multiple data sources to establish individualized investment plans.

18. The method of claim 11, wherein the rules based engine comprises a set of algorithms to provide the user with a holistic set of recommendations on how to achieve their goals.

19. The method of claim 11 further comprising a plurality of modular components for organizing and calculating different aspects of investment plans.

20. The method of claim 11 further comprising means for integrating new functionality for deriving risk capacity.
